(19) United States
(12) Patent Application Publication
(10) Pub. No.: US 2006/0025511 A1
(43) Pub. Date: Feb. 2, 2006

(54) Protective coating compositions, systems, and methods

(76) Inventors: Gary Silvers, Mission Viejo, CA (US); Ara Nercissiantz, El-Sereno, CA (US)

Correspondence Address: GANZ LAW, P.C., P O BOX 2200, HILLSBORO, OR, 97123, US

(21) Appl. No.: 11/129,157

(22) Filed: May 13, 2005

Related U.S. Application Data
(63) Continuation of application No. PCT/US03/36852, filed on Nov. 17, 2003.
(60) Provisional application No. 60/426,727, filed on Nov. 15, 2002.

(51) Int. Cl. C08K 3/34

(52) U.S. Cl. 524/445

(57) ABSTRACT

The invention relates to elastomeric compositions for use as temporary or semi-permanent protective coatings. The coatings are particularly useful to protect objects in transit. In certain embodiments, the compositions are based on monomer units of isoprene or isoprene derivatives. Preferably, the compositions include a reinforcement agent encapsulated in the polymer to reinforce the polymer structure, making it more resistant to environmental conditions, including heat and chemicals. Example reinforcement agents include particles of clays, ceramics, and/or nano-particles.

This application claims priority from U.S. Provisional Application Ser. No. 60/426,727, filed Nov. 15, 2002, and PCT Patent Application Serial No. PCT/US2003/036852, filed Nov. 17, 2003, the contents of which are hereby incorporated by reference as if recited in full herein for all purposes.

### BACKGROUND OF THE INVENTION

The present invention relates to removable protective coatings that may be applied to a variety of known surfaces. More particularly, the present invention relates to a transit coating for protecting objects in transit from environmental conditions and hazards.

Protective coatings are applied to surfaces of various objects to protect them from various forms of environmental damages. Known coatings include rinseable coatings based on acrylic and methyl methacrylate polymers. Protective coatings can be applied as a liquid composition by, for example, spray, brushing, or roll-on. In certain known coating systems, evaporation of the liquid base leaves a solid, elastomeric coating that may be peeled-off, without altering the surface to which it is applied. Unfortunately, such coatings not only lack certain desired functional attributes (detailed below) but also may be hazardous.

One example of the prior art is U.S. Pat. No. 6,124,044, the entire disclosure of which is hereby incorporated by reference. This patent generally discloses coating compositions comprising an emulsion selected from the group consisting of a vinyl acrylic copolymer and a vinyl acetate ethylene emulsion. The coating compositions are disclosed to be useful for, among other things, protection of vehicles from rail dust during transport. The compositions may include an inorganic, insoluble pigment that is finely divided but of an unspecified size. Examples include titanium dioxide and zinc oxide. The pigment is used to add color. The patent states that the pigment may also improve chemical stability of the composition through ultraviolet blocking, and it may contribute to mechanical strength of the dried composition by acting as filler, and it may help decrease the water sensitivity of the composition.

Protective coatings may remain in place for long or short periods, depending on the needs of the user. The conventional coatings suffer from various drawbacks, including difficulty in application to, or removal from, the target surface, inability to protect against a range of harmful environmental conditions, or the high cost of making or using the coating.

In one important application, which is provided for illustrative purposes only and not as limitation on the scope of the present invention, protective coatings are applied to the exterior surface of new cars being transported from the factory to distribution and sales centers. The coatings protect the surface from damage that might occur during transportation, preserving the automotive surface and its value, while eliminating the need for repairs and touch-ups. When cars are transported over railways, surfaces are particularly prone to damage from hot metal particles ejected or stirred-up by locomotives and rail cars. Conventional coatings applied to surfaces are not adequate at protecting the finish surface of the cars being transported because the hot metal particles penetrate the protective coating, damaging the finish of the car. Further, perforations or tears are exacerbated by internal tension within the coating and by external forces, such as wind forces generated, in for example, transportation of an item of cargo on a train, truck, ship, or plane. The degradation leads to further damage of the surface intended to be protected. Adapting conventional coatings to provide the necessary protection means compromising other desirable features in the coatings. For example, formulating thicker, more thermal resistant coatings comes at the cost of using thicker more expensive materials that are not easily applied to surfaces or removed from them and which require using hazardous chemicals considered environmentally unacceptable to most countries.

In view of the foregoing, there is a need for improved protective coatings that have certain qualities, including at least one or more of the following:
Protection of the automotive surface against various environmental conditions, including thermal, chemical, photodegradation, and physical hazards (hereinafter collectively called “environmental conditions”)
Easy application to a variety of surfaces and shapes
Easy removal from the applied surface without damage of material alteration of the surface
Reduced environmental impact
Lightweight and thin
Competitive cost relative to conventional solutions.

### SUMMARY OF INVENTION

The present invention provides novel protective coating systems that overcome the drawbacks in the prior art and address the foregoing needs.

In possible embodiment, the present invention contemplates composition for a protective coating comprising a liquid composition comprising isoprene or isoprene derivative and a reinforcement agent comprising substantially inert particles, the liquid composition being applicable to a surface of an object to form a removable, solidified, elastic coating.

In another possible embodiment, the present invention contemplates a composition for use as a protective coating for the surface of an object, the coating comprising a peelable polymer and a reinforcement agent distributed throughout the coating, the reinforcement agent comprising substantially inert particles larger than 200 nanometers.

In another possible embodiment, the present invention contemplates a composition for use as a protective coating for the surface of an object, the coating comprising a peelable polymer and a reinforcement agent distributed throughout the coating, the reinforcement agent comprising substantially inert particles smaller than 200 nanometers.

In another possible embodiment, the present invention contemplates an object having a surface, at least a portion of the surface having a protective coating comprising a peelable polymer network, the composition including a reinforcement agent comprising substantially inert particulates, the reinforcement agent being distributed in the polymer network to reinforce the network.

In another possible embodiment, the present invention contemplates an automobile having a protective coating peelably disposed on an exterior surface, the coating comprising a polymer composition based on isoprene of isoprene derivatives.

In another possible embodiment, the present invention contemplates a process for protecting the surface of a motor vehicle, comprising: providing a polymer composition based on isoprene or isoprene derivatives in a liquid form; applying the composition to the surface of a vehicle; and allowing the composition to solidify on the surface as a peelable film.

In another possible embodiment, the present invention contemplates a method of transporting an item of cargo, comprising: applying to an exterior surface of an item for shipment a peelable protective coating comprising: a polymer composition based on isoprene of isoprene derivatives; placing the object on transportation conveyance; and transporting the item to a desired destination on the conveyance. The transportation conveyance may be a rail car, ship, truck, or plane.

In another possible embodiment, the present invention contemplates a method of transporting an item of cargo, comprising: applying to an exterior surface of an item for shipment a peelable protective coating comprising a polymer composition and a reinforcement agent; placing the object on transportation conveyance; and transporting the item to a desired destination on the conveyance, wherein the reinforcement agent comprises substantially inert particles distributed throughout the composition.

In another possible embodiment, the present invention contemplates an object having an exterior surface, at least a portion of the surface having a protective coating comprising a peelable, elastic polymer based on isoprene or an isoprene derivative, the polymer being capable of vulcanizing or cross-linking based on a predetermined thermal contact.

In another possible embodiment, the present invention contemplates an object having an exterior surface, at least a portion of the surface having a protective coating comprising a peelable, elastic polymer, the polymer being capable of vulcanizing or cross-linking based on a predetermined thermal exposure.

In another possible embodiment, the present invention contemplates a method of protecting the surface of an object comprising applying to an exterior surface of the object a peelable, elastic polymer, the polymer being capable of vulcanizing or cross-linking based on a predetermined thermal exposure.

In some of the forgoing embodiments, the reinforcement agent may comprise substantially inert particles larger than 200 nanometers. In other embodiments, the reinforcement agent may comprise substantially inert particles smaller than 200 nanometers.

In one example, the novel protective coating system may be based on elastomeric polymer compositions based on isoprene or isoprene derivatives or other known monomer units for synthetic or natural rubber polymers. The polymer system is (1) pre-vulcanized or cross-linked or (2) self-vulcanizing or cross-linking under certain environmental conditions, such as exposure to heat. Such a polymer system is resistant to thermal exposure, for example, by rail dust containing hot particles, which may reach temperatures of up to 700° F. Accordingly, a novel aspect of the protective coating is its ability to protect surfaces from thermal and physical damage, as well as other environmental conditions. The polymer system also preferably includes a reinforcement agent that enhances the ability of the protective coating to resist damage from at least one or more environmental conditions. An advantage of the present invention is that when provided as an aqueous solution, mere evaporation of water renders a tough resilient elastic protective coating.

In another example, the protective coating composition includes an emulsion of polyisoprene natural-rubber latex, or a synthetic rubber (known as “latex”) and a reinforcement agent that consists of particles that are encapsulated by the polymer, adding reinforcement to the overall polymer composition. The contemplated reinforcement agents include, among other things, micronized clays, micronized ceramics, and/or nano-particles.

The composition may include other additives to impart desired characteristics. For example, it may include a rheological thickener that provides a composition that is thixotropically suitable for application to intended surfaces. Still other additives may include a peelability or elasticity agent, such as aliphatic oil that helps bind the coating system with improved peelable properties and improve elasticity or tensile strength of the coating.

The coatings of the present invention are particularly suitable for protecting items being transported, which are typically exposed to any number of environmental conditions. For example, high-temperature rail dust impacting the protective coatings based on isoprene or isoprene derivatives induces local sulfur vulcanization, making the protective coating stronger instead of weaker in the area of impact. This use of a vulcanized or vulcanizable polymer, or otherwise cross-linked or cross-linkable polymer, is a novel and enhanced aspect over the known transit protective coatings—which would weaken or fail on impact of rail dust. This degradation results in damage to the underlying finish surface and/or cause the damaged area to tear, spreading the damage beyond the area of impact. In contrast, the coating of the present invention, in response to thermal exposure, can toughen or strengthen instead of weaken.

Other embodiments of the present invention include methods of making and applying the compositions for protective coating. Other methods include protecting surfaces by applying the coating by spray application of the composition in a continuous film to the surface to be protected. Further methods relate to using the compositions to protect cargo in transit.

The polymer compositions of the present invention provide one or more of the following characteristics, which are advantageous in using the compositions as protective coatings: self-toughening on thermal exposure, higher crystallinity, higher melting point, higher shear modulus, and increased cross-link densities. Thus, the protective coatings based on the inventive compositions have better impact strength, hardness, useful temperature range, resiliency, resistance to water and other chemicals, and thermal resistance. The compositions provide such characteristics while retaining good elastomeric properties, applicability, and removability.

These and other embodiments are described in more detail in the following detailed descriptions and the figures.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1A-E are representative monomer units for polymer structures for use in a protective coating system according to the present invention.

FIG. 2A-E are further representative monomer units for use in a protective coating system according to the present invention.

FIG. 3 shows a peelable protective coating applied to an object.

### DETAILED DESCRIPTION OF THE INVENTION

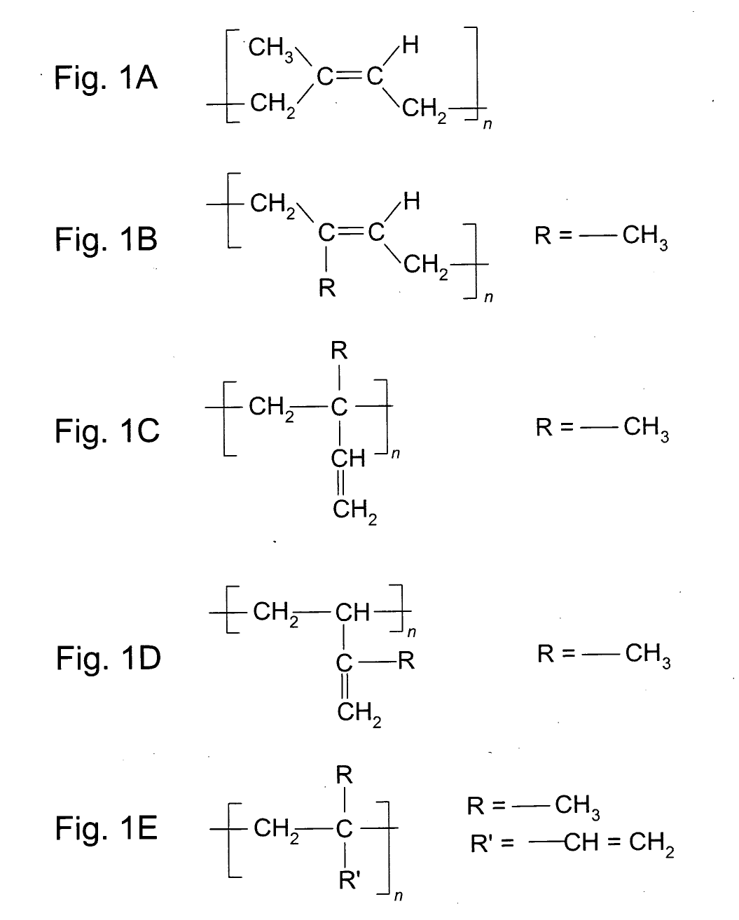

The present invention relates to a protective coating that may be used for a variety of known surfaces, including metal, wood, plastic, leather, glass, paint, or other synthetic or natural surface materials. In certain embodiments, the protective coating systems are based on elastomeric polymers having isoprene or isoprene derivatives as the monomer units. For example, the useful polymers are contemplated to include natural and synthetic latex polymers. FIG. 1A-E show a basic isoprene unit and representative isoprene derivative units that may be used in the present invention. As used herein, “polymer” may be combination of one or more of the monomers. Polymers so composed provide enhanced protection through their conjugated backbone. Vulcanization or a vulcanizing agent, such as sulfur or sulfur-based compounds, or cross-linking agents, known in the art, provide (1) pre-existing vulcanization and/or (2) supplemental cross-linking or vulcanization under certain conditions that activate vulcanizing or cross-linking agents. For instance, localized, supplemental vulcanization can occur on exposure to thermal conditions such as hot rail dust. In contrast, conventional coatings on the market will either melt or will not give localized increase in cross-linking and vulcanization upon impact-and therefore, cannot provide the enhanced protection of the present invention.

More particularly, the polymer system used in the invention provides multiple routes of continued toughening and cross-linking via free-radical initiated polymerization, as well as sulfur vulcanization, combined with rubber-like and elastomeric properties of polyisoprene-based rubber latex. This toughening results in a polymer system able to reach high levels of cross-linking, while retaining elastomeric properties due to, for example, the latex polymer in the free molecular volumes in the cross-links. The increased cross-link density, as a result of the polymer being able to further cross-link via free-radical and sulfur-based vulcanizations, can reduce molecular volume in amorphous regions and increase glass transition temperature, hardness, and toughness. Higher cross-link densities and decreased intermolecular volume in the amorphous regions of the polymer increase heat resistance, and the cross-linked elastomers increase rubber-like elasticity at higher temperatures and for longer periods of time. Accordingly, the polymers provide exceptional mechanical properties, including impact and heat resistance.

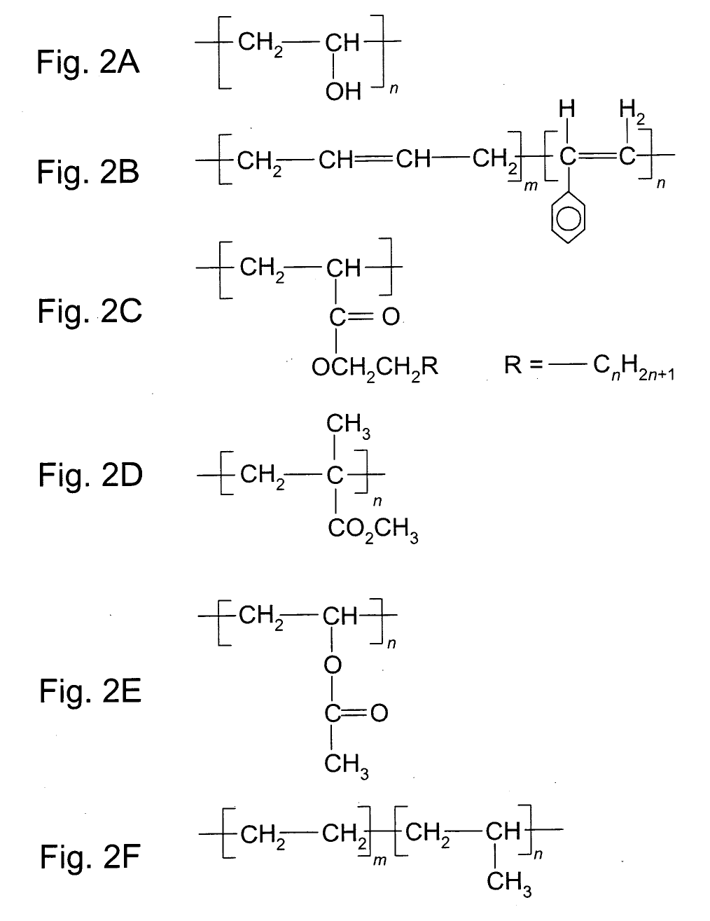

In addition to natural-latex-based polyisoprene polymers contemplated above, synthetic rubbers are also contemplated, particularly when enhanced by reinforcement agents, described below. Representative monomer units are shown in FIG. 2A-E. Synthetic rubber and latex polymers can include polyvinyl alcohol (FIG. 2A), polyvinyl acetate (FIG. 2E), polyacrylic acid and poly(alkylacrylate) polymers (FIG. 2C) , polymethylmethacrylate polymers (FIG. 2D), styrene butadiene rubber, butadiene styrene rubber, nitrile rubber, butadiene acrylonitrile, butyl rubbers, isobutylene isoprene, polybutadiene rubbers, butadiene rubbers, ethylene propylene rubbers (FIG. 2F), and styrene butadiene lattices (FIG. 2B).

Polyisoprene latex polymers may include, for example, latex polymer 62cx125467 from Chemionics Corporation of Talimadge, Ohio and Killian™ polyisoprene latex Polymer NLPV10811902 from Killian Latex, Inc. of Akron, Ohio.

In the present invention, polymer compositions of monomers or polymer units are provided in liquid form, such as a water-based emulsion. The liquid composition is applied to the surface of an object, where the composition polymerizes into a polymer network that is a thin film or sheet coating on the surface. The coating should have elasticity and peelability. The formulation of the liquid compositions from the components taught herein is well within the ordinary skill of persons in the art to which this invention pertains.

To achieve significantly improved protective coatings, an elastomeric polymer composition includes a reinforcement agent that enhances the polymer's native ability to resist against damage from one or more environmental conditions, such as heat or abrasion. The reinforcement agent may be substantially inert macroscopic or microscopic particles that are incorporated into the polymer. In certain embodiments, the reinforcement agent is a mirocronized particle that is believed to be encapsulated by the polymer in the molecular volume between cross-links. Typically, the particle would be an inert substance. It may have some reactivity, however, if it permits the functionality described below.

Using the natural or synthetic elastomeric polymers with reinforcement agents improves material properties of the polymer by introducing a network of many fixed or substantially fixed points, which help stiffen and strengthen the polymer. Simultaneously, the reinforcement agent interacts with the polymer to help crystallize at high elongation by the resulting system's bulkiness. Because the reinforcement agent imparts rigidity, it increases the crystallinity in the polymer's amorphous regions, and also increases the polymer's shear modulus.

It is believed that the degree of reinforcement is increased by a reduction in the particle size of the reinforcement agent. As particle size decreases, especially to the order of nano-particles, the interface between polymer and particle is believed to increase, resulting in reinforcement of the elastomer. A range of micronized particle sizes are contemplated, so long as they can be encapsulated according to the foregoing principles. In the case where nano-particles, such as nanocomposites, are used as the reinforcement agent, suitable particle diameters (or sieving size) are contemplated to include the range of from about 2 to about 200 nanometers.

The reinforcement agent is a substantially inert, inorganic substance, which should have inherent thermal resistivity or flame retardancy. Generally, for example, the reinforcement agent may be based on particles of clay, including kaolin, other clay-like particles, or ceramics. Other examples of reinforcement agents include nano-particles, colloidal silicas, nanosystems based on aluminum alkoxides, and nanosystems and ceramic nanocomposites based on Nanomers™ from Nanocor of Arlington Heights. Still other examples include calcined kaolines, Santintone W, calcined kaolins including Satintone®V, Satintone 5, Satintone Plus, Satintone SP-33, Satintone O P, Satintone W, Whitetex R, and other calcined aluminosilicates from Engelhard Inc. of Iselin, N.J. Still other examples include nanoclay reinforcing fillers for nanocomposites, including nanocor nanocomposites from Nanocor, montmorilonite, and nanomer from Nanocor; aluminum sec-butoxides; and colloidal silicas, including Ludox™ colloidal silicas, such as Ludox™ AS-30 and Ludox™ TMA from W.R. Grace Co. of Columbia, Md. The foregoing are just some examples, and from the teachings herein persons skilled in the art will be able to recognize many other macro and microscopic particulate materials that will be suitable as reinforcement agents.

The compositions of the present invention may also include other agents to enhance selected properties. For example, a peelability agent may be added to improve the peelability of the protective coating from a surface to which it is applied. For instance, aliphatic oil may be included in the composition to function as a peelability agent, elasticity agent, or both. Preferably, the saturated aliphatic oils are used for their low reactivity relative to unsaturated aliphatics. Suitable aliphatics may include mineral oils or paraffins.

A rheological agent may be added to provide the composition with desired rheological properties needed for suitable application of the protective coating or for appearance. For example, embodiments of the present invention may include a rheological additive/thickener that makes the composition attain viscoelastic properties so that it can be more easily applied and maintained on vertical surfaces. For instance, additives such as xanthene gum give the coating thixotropic and rheological properties that result in higher thixotrophy. These additives enable a surface coating that will not sag or flow off the surface of treatment and provide consistency in the thickness of the coating. Rheological and thickening materials may include about 0.05 to about 5% of Veegum™ agents, such as Veegum R, Veegum HV, or Veegum A116M from R.T. Vanderbilt Inc. of Norwalk, Conn.; about 0.05% to about 0.5% xanthene gum or Veegum colloidal magnesium aluminum silicate, Natrasol 250 MHR, Natrasol 250 LR, or Natrasol MR hydroxyethyl cellulose from Hercules Incorporated of Wilimington, Del.; organically modified montmorillonoite clay, such as Claytone™ 38 H hectorite from Southern Clay Products, Inc. of Gonzales, Tex.; Bentone 27 from Elementis Specialties, Inc. of Hightstown, N.J., and Acrysol 820 from Rohm and Haas Company of Philadelphia, Pa.

A chelating agent may also be included in the compositions of the present invention to bind ions introduced into the composition by, for example, aqueous components or other components. If not treated with a chelating agent, such ions may interfere with polymer networking.

The coating compositions may also include antioxidant or UV stabilizer systems for scavenging of free radicals. For example, these may include 2-(2-hydroxy-3-t-butyl-3-butyl-5-(-octyloxycarbonyl)ethyl-phenyl)2H-benzotriazole, sterically hindered tertiary amines, bis(1,2,2,6,6,-pentamethyl-4-piperidinyl) sebacate, poly (oxy-1,2-ethanediyl), and alpha-(3-(3-(2H-benzotriazol-2-yl)-5-(1,1-dimethylethyl)4-hydroxyophenyl)-1-oxopropyl-hydroxy.

Other UV and light stabilizers or free radical scavengers that may be used with in the compositions include sterically hindered amines (HALS), photo reactive HALS, Sanduvor 3041 dispersion, (Benzophonone), Sanduvor 3051 non-substituted radical scavenger (HALS), Sanduvor (mixture of benzotriazole with non-substituted HALS, and Sandostab P-EPQ antioxidant, ethane diamide, n-(2-ethoxyphenyl)-n-(4-ethyl phenyl).

For stabilization against thermal oxidation, stabilizing agents may be used in the compositions. They include polyhydric phenols, ortho or para type, hindered bisphenols, metal complexes of phenols, phosphite esters, hindered monohydric phenols, and secondary arylamines. Stabilization against oxidative photodegradation may be provided via phenyl salicylate, resorcinol monobenzoate, or 2,4-dihydroxybenzophenone, 2,4-dihydroxybenzophenone. Prevention against ionizing radiation may be achieved using N-pheyl-N′-o-tolylethylenediamine, 6-phenyl-2,2,4-trimethyl-1,2dihydroquinoline, 2-naphtylamine, or 2-naphtol, p-quinone.

To help stabilize the compositions against burning, the compositions may include one or more of the following: hydrated alumina, anhydrous alumina, aluminum sec-butoxides, or colloidal silica Ludox AS-30 and Colloidal Silica Ludox TMA. Other stabilizers that may be used include Tinuvin 292 from Ciba Geigy (which is a hindered tertiary amine), light stabilizer, and Tinuvin 928 (which is a hydroxyphenyl benzotriazole light stabilizer).

The present invention may be formulated as a semi-permanent, water-based coating that offers improved properties, including unique high-temperature resistant surface protection of metal, wood, plastic, leather, glass, paint, or other surface materials. Applied as a liquid composition by spray, brushing, roll-on, etc., the invention upon evaporation has polymerized, leaving an elastomeric solid coating that is peelable or otherwise easily removable. The coatings of the present invention help protect surfaces from damage from a variety of environmental conditions (including physical damage, such as that by physical contact with large and small objects, particles, and dust); ozone; heat; chemical conditions (such as water, acids/bases, oxidizers, etc.); and photodegradative damage (for example, from sunlight and other sources of UV light).

In one possible embodiment, the composition includes a polymer of about 15% to about 40% by weight of latex; between about 15% to about 35% water; a reinforcement agent of about 14% to about 24% micronized clay in an about 0.1% to about 25% water based polyurethane emulsion resin; a peelability/elasticity agent of an aliphatic oil at about 5% to about 30%; and a rheological agent of about 0.05% to about 0.5% xanthene gum. This composition may further include an optional anti-swelling agent of triethanolamine at about 0.1% to about 1.0%, an optional anti-foaming agent, and/or an optional fragrance. (Note: in this document, all percentages of composition components are weight percentages.)

A preferred method of protecting surfaces according to this invention includes steps of applying the coating by spray application of the composition in a continuous film to the surface to be protected. In addition to spraying, the coating may be applied in other conventional ways used to apply paint. An advantage and improvement of a polyisoprene-based protective coating system is that mere evaporation of water renders a tough resilient elastic coating. The coating may be applied in desired thickness. For most applications, about 10 to about 15 mils should be sufficient. The coating may be applied thicker for higher levels of protection. Coatings of 25 mils or thicker can be possible with the proper selection of rheological and thickening agents.

Another advantage of this invention is its easy peelability relative to other known protective coatings. The peelability agent/elasticity agent in the form of, for example, aliphatic oil enhances the compositions so that both the peelability as well as elastomeric properties of the coating are improved.

In another coating system that can be more suitable for transit coating for surfaces with fresh paint, the coating composition contains about 35% to about 45% of water; about 0.2 to about 0.4% xanthene gum; about 0.05% to about 0.3% triethanolamine; about 1% to about 8% SF-49 clay filler/reinforcing agent; about 40 to about 60% polyisoprene latex polymer # 3062-448 (from PolyOne Corp. of Avon Lake Ohio); and about 0.2 to about 0.6% Tinuvin 348 UV stabilizer, as well as preservative.

In another possible embodiment, the coating composition contains between about 10% to about 28% of latex as the base polymer; a heat retarding agent (for example, a known heat retardant, such as about 1% to about 5% flame retardant Reofos 1884); about 10% to about 25% water; 1% to about 3% anionic dispersion of an aliphatic polyester urethane polymer in water/n-methyl-2-pyrrolidone, which acts a an abrasion resistance agent; about 20% to about 30% micronized clay as the reinforcement agent; and Satintone 100 as a reinforcement agent or filler. The composition may also include a thickening agent, such as xanthene gum having a concentration of between about 0.1% to about 1% by weight, added to a system that has been premixed with triethanolamine at about 0.1% to about 0.3% concentration. The composition may optionally include a fragrance of about 0.1% to about 0.3%. It is noted that the addition of the heat-retarding agent supplements or complements the heat resistance properties of the reinforcement agent. Similarly, the addition of the abrasion resistance agent supplements or complements that of the reinforcement agent.

The foregoing surface protective coating was tested by exposure to glacial muriatic acid, 10 N NaOH. No material adverse effect was observed on the surface of the peelable coating.

Testing of the Protective Coating

A surface of an automotive painted panel is coated with preferably 10-15 mils of a protective coating according to the present invention. (See composition XP2-19A described below).

A 3-inch×0.25-inch metal bar, weight 8.88 gms, was heated on an oxygen torch to a point when the metal tip of bar just turned red, which took about 3-5 seconds. The hot bar was immediately dropped on the treated surface from a height of about 2-3 inches to determine the surface's resistance to impact and heat (hot rail-dust resistance test). The bar was left in contact with the treated surface for at least 3 to 5 seconds, after which time most of the heat had been dissipated. The results of this and other tests on the treated surface are summarized below in Table 1.

TABLE 1

| Protective coating XP2-19A (A | |
|---|---|
| protective coating according to the | |
| present invention suitable for | |
| protecting cargo in rail transit) | |
| Impact of | Withstands impact |
| ˜350° C. hot metal (Rail dust test) | Protects coated surface |
| Ease of peeling | Elastomeric film peels off easily |
| Recycling advantages | Film can be recycled |
| Durability to heat | Withstands flame after 10 passes |
| Evaporation | Water evaporation - 20 minutes- |
| Thickness | for each increment of 1-5 mils. |

Typical physical properties of a transit coating XP2-19A are as follows:

TABLE 2

| | | | |
|---|---|---|---|
| Appearance | Opaque off white | Haps Content | 0 |
| | Lotion | | |
| Flash Point | N/A | SARA | 0 |
| | | Content | |
| pHRange | 9.5-10.5 | VOC | Minimal to none |
| | | | (Aqueous based |
| | | | system) |
| Viscosity | 3500-4500 CPS | Specific | 1.00-1.15 gms/ml |
| Range | Spindle #4/10 RPM: | Gravity | |
| | 77° F. | | |

To stabilize the system against UV and oxidation, 0.5-2% of 2-2hydroxy-3-t-butyl-5-(2-octyloxycarbonylethylphenyl 2H-benzotriazole was used.

The coating composition can be made by conventional means, typically including steps of simply admixing the components (or aqueous solutions, dispersions, etc. thereof) at atmospheric pressure and ambient temperature so as to form a homogeneous mixture. In one embodiment using a rheological agent of xanthene gum, the xanthene gum is added to water and mixed, followed by addition of an optional swelling agent of triethanolamine. It has been found that the mechanical and thermal properties of the coating of the invention can be controlled by appropriate combination and adjustment of pH of the polyisoprene latex solution to a range typically between 9.5-10.5 pH range for best stability.

Appropriate wetting of a reinforcement agent of a clay powder can be facilitated by inclusion of mineral oil, as well as 0.01-0.3% of surfactant such as Monamulse DBE, Monamulse 1255, or other known surface active agents. Proper dispersion of the clay powder will result in high coating and film quality. Care should be taken when adding powders to the system. It is preferred that all powders be predispersed in the water system, before addition of the resin. Proper care should be taken that the mixing is done at a rate that will not cause gelling or shocking of the latex polymer. Proper mixing and uniformity of the system will result in enhanced mechanical properties, no pinholes -or no surface defects, and ease of palpability of the dried coating.

The present invention also includes a method of protecting surfaces where a continuous film of the surface protective coating composition is applied to the surface to be protected. Such surfaces may include the exterior painted portions of an automobile or other vehicle. The coating composition may be applied by any one of a variety of known techniques. Preferred techniques include brushing and spraying of the surface with the coating composition. Thereafter, the coating composition may be applied with a pressure-pot sprayer. The coating composition is sprayed primarily on the surface to be protected, although overspray will not pose significant problems since any overspray may be readily removed, for example by a wet towel or sponge. Other techniques include those that can be used to apply paint.

After application, the coating composition is permitted to dry, normally at atmospheric temperatures and pressures. Such drying will take about 20 minutes for each thickness increment of about 1-5 mil in typical applications at ambient temperature.

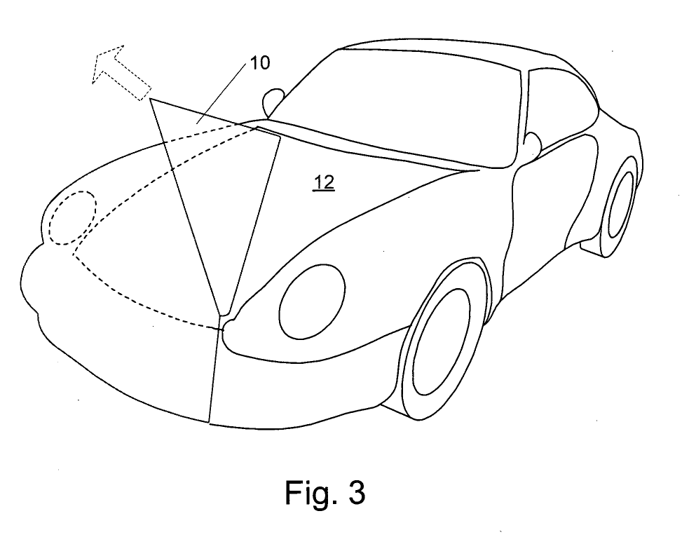

The invention further can include a method of protecting surfaces from scratches. Generally, the above-described surface protective coating composition is applied to the surface to be protected, and the protective coating is then removed by peeling the coated surfaces. For example, cars to be loaded onto auto-carriers (either road or rail) are first cleaned of surface debris and dust and then coated with the surface protective coating composition of the invention as described above. The cars are then transported to their destination where the surface protective coating is removed by peeling the transit coating. For example, FIG. 3 illustrates a thin-film coating 10 according to the present invention being peeled from the surface 12 of an automobile. The coating may be applied over some or all surfaces of an object. Generally, the coating would be applied to form an intact sheet. However, a protective effect may be achieved even if the sheet has, for example, apertures, channels, or other voids. The invention may also be useful if applied in strips, sheets, or other geometries. The protective effect is achieved wherever the coating serves as a buffer against contact or exposure to environmental conditions. For instance, if apertures in a sheet are smaller than objects that may contact the coated surface, the surface may be effectively buffered from contact. Similarly, spaced arrays of coating material may effectively protect not only the surface areas directly coated but also the uncoated areas, depending on the nature of the possible contact or exposure.

The following are specific examples of protective coating compositions. They are intended to illustrate the present invention and are not intended to limit the scope of the invention.

General Purpose Protective Coating:

TABLE 3
Example Composition 1 (XP2-1A)

| Ingredient | Wt % |
|---|---|
| H₂0 | 33.3 |
| Xanthene gum | 0.17 |
| Triethanolamine | 0.25 |
| Urethane emulsion (Bayhydrol 110) | 0.60 |
| Kaolin clay | 18.00 |
| Polymer (# 3062-448) (Latex) | 30.70 |
| Waterbased Antifoam # 89 (from | 0.05 |
| General Electric) | |
| Fragrance oil | 0.12 |
| Mineral Oil | 16.70 |
| Preservative | 0.30 |
| | 100.00 |

TABLE 4
Example Composition 2: (XP2-1A)

| Ingredient | Wt % |
|---|---|
| H₂0 | 32.11 |
| Xanthene gum | 0.17 |
| TEA | 0.25 |
| Satintone 100 | 18.00 |
| Urethane emulsion (Bayhydrol 110) | 0.60 |
| Latex Polymer # 3062-448 | 30.70 |
| Waterbased Antifoam # 89 | 0.05 |
| Fragrance 201 | 0.12 |
| Mineral Oil | 16.70 |
| Tinuvin 384 | 1.00 |
| Preservative | 0.30 |
| | 100.00 |

Contemplated uses of compositions 1 and 2 include general-purpose peelable protective coating for wood and other surfaces.

TABLE 5
Example Composition 3: (XP2-19A)

| | |
|---|---|
| Ingredient | Wt. % |

| | |
|---|---|
| H20 | 41.53 |
| Xanthene Gum | 0.36 |
| Triethanolamine | 0.18 |
| SF-49 Filler | 2.50 |
| Latex Polymer | 54.97 |
| Tinuvin # 348 | 0.46 |
| | 100.00 |

Example composition 3 is contemplated for use on recently painted surfaces, e.g., as a new-car transit coating.

Where the present invention is intended for use on recently painted surfaces, the composition may need some customizing to help avoid interaction with the paint. For example, in XP2-19A, the level of the SF-49 clay filler, available from Kaopolite, Inc. of Union, N.J. and Latex Polymer have been adjusted, and Polyurethane emulsion (Bayhydrol 110) has been removed for minimal marking on fresh paint systems. The Satintone 100 filler component has been replaced with SF-49 filler for best results on fresh paint. Continued testing on panels freshly painted black proved to show impressive performance on partially cured painted panels).

The foregoing embodiments and features are for illustrative purposes and are not intended to be limiting, persons skilled in the art being capable of appreciating other embodiments from the scope and spirit of the foregoing teachings.

What is claimed:

1. A composition for a protective coating comprising a liquid composition comprising isoprene or isoprene derivative and a reinforcement agent comprising substantially inert particles, the liquid composition being applicable to a surface of an object to form a removable, solidified, elastic coating.

2. The composition of claim 1 wherein the reinforcement agent comprises of substantially inert particles comprising one or more of clay, ceramic, micronized clay, and micronized ceramic, wherein the reinforcement agent comprises particles of from about 2 to about 200 nanometers in size.

3. The composition of claim 1 wherein the liquid composition comprises one or more of polyvinyl alcohol, polyvinyl acetate, polyacrylic acid and poly(alkylacrylate) polymers, polymethylmethacrylate polymers, styrene butadiene rubber, butadiene styrene rubber, nitrile rubber, butadiene acrylonitrile, butyl rubbers, isobutylene isoprene, polybutadiene rubbers, butadiene rubbers, ethylene propylene rubbers, and styrene butadiene lattices.

4. The composition of claim 1 wherein the coating is peelable from a surface further comprising metal, wood, leather, plastic, paint, fiberglass, rubber, glass, stone, ceramic, or vinyl.

5. The composition of claim 1 wherein the coating comprises a peelable polymer, and wherein the reinforcement agent is distributed throughout the coating, and comprises substantially inert particles of more than about 200 nanometers in size.

6. An object having a surface, wherein the surface portion comprises metal, wood, leather, plastic, paint, fiberglass, rubber, glass, stone, ceramic, or vinyl, and at least a portion of the surface having a protective coating comprising a peelable polymer network, the composition including a reinforcement agent comprising substantially inert particles, the reinforcement agent being distributed in the polymer network to reinforce the network.

7. The object of claim 6 wherein the object is an automobile having a protective coating peelably disposed on an exterior surface, the coating comprising a peelable polymer, and a reinforcement agent comprising one or more of a clay or ceramic.

8. The automobile of claim 7 wherein the protective coating is peelably disposed on an exterior surface, the coating comprising a polymer composition based on isoprene or isoprene derivatives comprising one or more of polyvinyl alcohol, polyvinyl acetate, polyacrylic acid and poly(alkylacrylate) polymers, polymethylmethacrylate polymers, styrene butadiene rubber, butadiene styrene rubber, nitrile rubber, butadiene acrylonitrile, butyl rubbers, isobutylene isoprene, polybutadiene rubbers, butadiene rubbers, ethylene propylene rubbers, and styrene butadiene lattices.

9. A method of coating an item of cargo to be transported, comprising: applying to an exterior surface of an item for shipment a peelable protective coating comprising a polymer composition and a reinforcement agent, wherein the reinforcement agent comprises substantially inert particles distributed throughout the composition.

10. The method of claim 9 wherein the reinforcement agent comprises substantially inert particles comprising one or more of clay and ceramic.

11. The method of claim 9 wherein the reinforcement agent comprises particles of from about 2 to about 200 nanometers, micronized clay, and ceramic or substantially inert particles of more than about 200 nanometers in size distributed throughout the coating.

12. The method of claim 9 wherein the reinforcement agent comprises substantially inert particles of more than about 200 nanometers in size distributed throughout the coating.

13. An object having an exterior surface, at least a portion of the surface having a protective coating comprising a peelable, elastic polymer, the polymer being capable of vulcanizing or cross-linking based on a predetermined thermal contact.

14. A method of protecting the surface of an object comprising applying to an exterior surface of the object a peelable, elastic polymer, the polymer being capable of vulcanizing or cross-linking based on a predetermined thermal exposure.

15. The composition of claim 1 wherein the coating comprises a peelable polymer, and wherein the reinforcement agent comprises substantially inert particles of less than about 200 nanometer in size distributed throughout the coating.

16. The object of claim 6 wherein the coated surface comprises wood.

17. The method of claim 9 wherein the reinforcement agent comprises substantially inert particles of less than about 200 nanometers in size distributed throughout the coating.

18. The method of claim 10 wherein the reinforcement agent comprises substantially inert particles of less than about 200 nanometers distributed throughout the coating.

19. The method of claim 9 wherein the coating is applied as a liquid composition that solidifies into the peelable, elastic coating.

20. The method of claim 19 wherein the composition includes a rheological agent for imparting a desired viscosity.
